(19) United States
(12) Patent Application Publication
(10) Pub. No.: US 2025/0384664 A1
(43) Pub. Date: Dec. 18, 2025

(54) IMAGE CLASSIFICATION MODEL TRAINING USING LATENT-BASED CLUSTER FILTERING AND ALIGNED SUBSET SELECTION

(71) Applicant: The Toronto-Dominion Bank, Toronto (CA)

(72) Inventors: Cheng Chang, Toronto (CA); Keyu Long, Toronto (CA); Ted Li, Toronto (CA); Himanshu Rai, Toronto (CA); Maksims Volkovs, Toronto (CA)

(73) Assignee: The Toronto-Dominion Bank, Toronto (CA)

(21) Appl. No.: 19/239,431

(22) Filed: Jun. 16, 2025

Related U.S. Application Data
(60) Provisional application No. 63/659,887, filed on Jun. 14, 2024.

(51) Int. Cl. G06V 10/764; G06V 10/74; G06V 10/762; G06V 10/774; G06V 10/776

(52) U.S. Cl. CPC G06V 10/764; G06V 10/761; G06V 10/762; G06V 10/774; G06V 10/776

(57) ABSTRACT

An example operation may include at least one of converting an annotated dataset loaded from a storage into a first set of latents, converting a non-annotated dataset loaded from the storage into a second set of latents creating an aligned subset of data from the annotated dataset comprising: clustering the first set of latents into a plurality of clusters, determining a discrepancy score for each cluster in the plurality of clusters and the second set of latents, creating a refined subset of data from the annotated dataset by including at least one data from each cluster of the plurality of clusters, wherein adding the at least one data lowers the discrepancy score of the refined subset of data and the second set of latents, determining a similarity score between latents in the first set of latents and the second set of latents, wherein the aligned subset of data is created from the annotated dataset by parsing the refined subset into pairs of latents and for each of the pairs of latents, including a latent with a highest similarity score, and training an image classification model using the aligned subset, the image classification model configured to classify image data received from a user device.

### CROSS-REFERENCE TO RELATED APPLICATIONS

This application claims priority to U.S. Provisional Application No. 63/659,887, filed on Jun. 14, 2024, the entire disclosure of which is incorporated by reference herein.

This application is related via subject-matter to U.S. application Ser. No. 18/817,329, filed on Aug. 28, 2028, U.S. application Ser. No. 19/239,320, filed on Jun. 16, 2025, and U.S. Application Docket No. 24200-DAI-US-PAT4, entitled “CLASSIFIER-GUIDED DATASET COMPRESSION USING DISTRIBUTION-AWARE SELECTION”, filed on Jun. 16, 2025, the entire disclosures of which are incorporated by reference herein.

### BACKGROUND

Conventional machine learning systems often rely on full annotated datasets for training, leading to substantial computational overhead and inefficiencies in adapting to new or shifting target domains.

### SUMMARY

An instant apparatus includes a memory communicatively coupled to a processor, wherein the processor may perform at least one of convert an annotated dataset, stored in the memory, into a first set of latents, convert a non-annotated dataset, stored in the memory, into a second set of latents, cluster the first set of latents into a plurality of clusters, determine a discrepancy score between each cluster in the plurality of clusters and the second set of latents, create a refined subset of the annotated dataset by including at least one data item from each cluster, wherein including the at least one data item lowers the discrepancy score between the refined subset and the second set of latents, create a similarity score between latents in the first set of latents and the second set of latents, generate an aligned subset of the annotated dataset by parsing the refined subset into pairs of latents and, for each of the pairs of latents, including a latent with a highest similarity score, and train an image classification model using the aligned subset, wherein the image classification model is configured to classify image data received from a user device.

An instant method includes at least one of converting an annotated dataset loaded from a storage into a first set of latents, converting a non-annotated dataset loaded from the storage into a second set of latents creating an aligned subset of data from the annotated dataset comprising: clustering the first set of latents into a plurality of clusters, determining a discrepancy score for each cluster in the plurality of clusters and the second set of latents, creating a refined subset of data from the annotated dataset by including at least one data from each cluster of the plurality of clusters, wherein adding the at least one data lowers the discrepancy score of the refined subset of data and the second set of latents, determining a similarity score between latents in the first set of latents and the second set of latents, wherein the aligned subset of data is created from the annotated dataset by parsing the refined subset into pairs of latents and for each of the pairs of latents, including a latent with a highest similarity score, and training an image classification model using the aligned subset, the image classification model configured to classify image data received from a user device.

An instant computer readable storage medium comprises instructions, that when read by a processor, cause the processor to perform at least one of loading an annotated dataset from a storage into a first set of latents, converting a non-annotated dataset loaded from the storage into a second set of latents creating an aligned subset of data from the annotated dataset comprising: clustering the first set of latents into a plurality of clusters, determining a discrepancy score for each cluster in the plurality of clusters and the second set of latents, creating a refined subset of data from the annotated dataset by including at least one data from each cluster of the plurality of clusters, wherein adding the at least one data lowers the discrepancy score of the refined subset of data and the second set of latents, determining a similarity score between latents in the first set of latents and the second set of latents, wherein the aligned subset of data is created from the annotated dataset by parsing the refined subset into pairs of latents and for each of the pairs of latents, including a latent with a highest similarity score, and training an image classification model using the aligned subset, the image classification model configured to classify image data received from a user device.

### BRIEF DESCRIPTION OF DRAWINGS

FIG. 1 is a system diagram illustrating an operating environment of a software service, according to examples and features of the instant solution.

FIG. 2A is a system diagram illustrating integration of an artificial intelligence (AI) model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a chatbot service that utilizes an AI model of the instant solution, according to the examples and features of the instant solution.

FIG. 2E is a sequence diagram depicting a chatbot service interaction according to examples and features of the instant solution.

FIG. 3A is a system diagram illustrating a system for scoring latent vectors, performing filtering, constructing similarity graphs, generating refined subsets, and training models using selected data according to the examples and features of the instant solution.

FIG. 3B is a sequence diagram showing data upload, latent conversion, filtering, subset generation, training, and output of model performance metrics according to the examples and features of the instant solution.

FIG. 3C illustrates a system for training and deploying a visual classification model according to the examples and features of the instant solution.

FIG. 4A is a flow diagram illustrating a flow diagram of a method for generating a refined subset of annotated data based on latent clustering, cluster discrepancy evaluation, and similarity scoring with respect to a non-annotated dataset according to examples and features of the instant solution.

FIG. 4B is another flow diagram illustrating a flow diagram of a method for generating a refined subset of annotated data based on latent clustering, cluster discrepancy evaluation, and similarity scoring with respect to a non-annotated dataset according to examples and features of the instant solution.

FIG. 5 is a system diagram illustrating a computing environment according to the instant solution's example features, structures, or characteristics.

### DETAILED DESCRIPTION

In machine learning workflows (particularly for computer vision tasks such as image classification or object detection) model training often uses large volumes of annotated data. However, obtaining high-quality labeled datasets is costly and time-consuming, while non-annotated data (such as raw image streams from user devices) is typically abundant. A persistent challenge lies in efficiently aligning these disparate datasets to train accurate models without incurring excessive annotation costs or introducing domain mismatch errors between training and deployment environments.

The instant solution addresses this challenge by generating an aligned and refined subset of annotated data, optimized for training visual models on real-world, unlabeled inputs. The instant solution employs a combination of latent vector clustering, distributional discrepancy scoring, and similarity-based graph pruning to identify and retain the most relevant annotated samples. These selected samples are used to train a visual classification model that is aligned with the distribution of data observed in deployment, such as image streams captured by a user device resulting in a system that offers improved model generalization, reduced annotation overhead, and enables practical deployment of visual classifiers in resource-constrained or personalized environments.

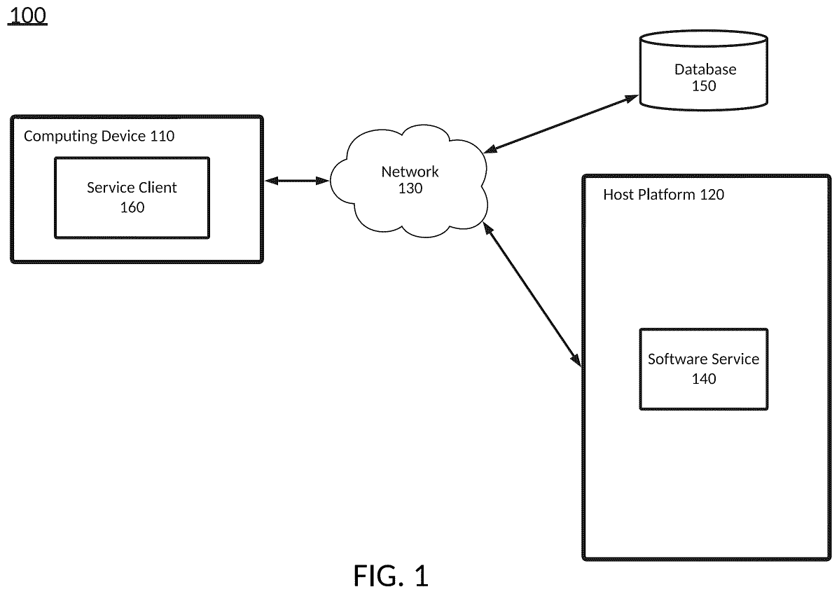

FIG. 1 is a system diagram 100 illustrating an example operating environment of the instant solution. As shown, at least one computing device 110, and a host platform 120 communicate via a network 130. The host platform 120 may host a software service 140. The software service 140 may communicate with at least one database 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include at least one interconnected computer network. For example, network 130 may be or may include an Ethernet network, an asynchronous transfer mode (ATM) network, a wireless network, a telecommunications network or the like.

The software service 140 provides the service logic. It may provide at least one Application Programming Interface (API) for communicating with at least one service client 160. A “thick” user interface (UI) client that runs on a computing device 110 may utilize the APIs to communicate with the software service 140. Further, the software service 140 may provide hosted UIs that can be accessed through browser-based software on some computing devices 110.

The at least one service client 160 can enable service access for end users and may come in a variety of forms including, but not limited to, a mobile device application (“app”) or a web portal accessed via a browser on a computing device 110 such as a laptop or desktop computer.

Detailed descriptions of the architecture and operation of the image classification model training using latent-based cluster filtering and aligned subset selection service in the instant solution are further described and depicted herein.

The instant solution is at least partially implemented through logic executed by the service client 160 and/or the software service 140. For example, the service client 160 may initiate or schedule data upload from the computing device 110, including both annotated and non-annotated image data. The software service 140 may receive these datasets and perform latent vector conversion, clustering, discrepancy scoring, similarity computation, and pruning operations as further described in later figures. The service client 160 may render user interfaces to present subset refinement results, training metrics, or classification outputs, either retrieved via the software service 140 or derived locally. The host platform 120 may coordinate model training workflows using the refined and aligned subset of annotated data and may further support deployment of trained classification models to computing devices 110.

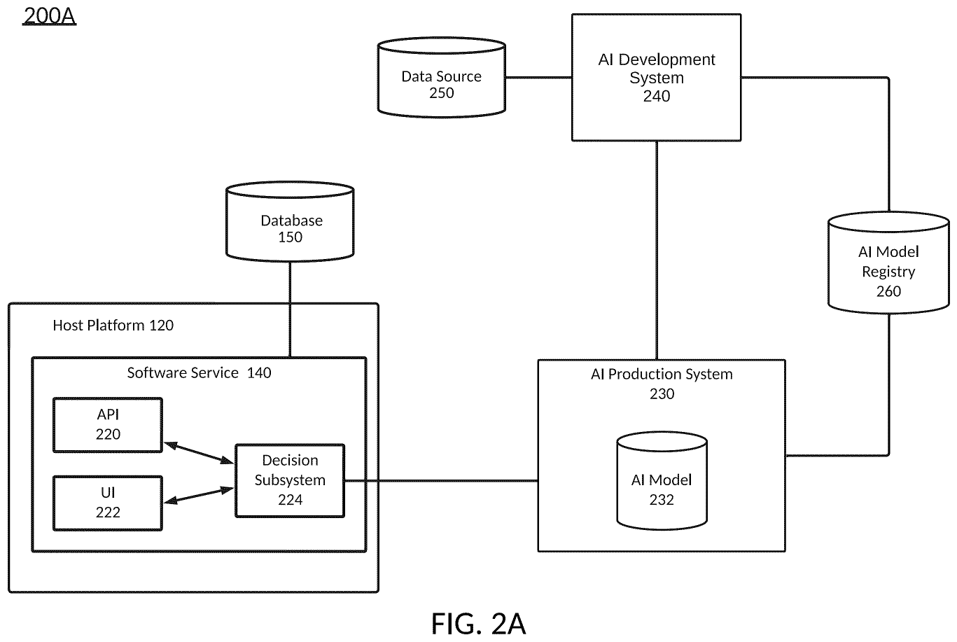

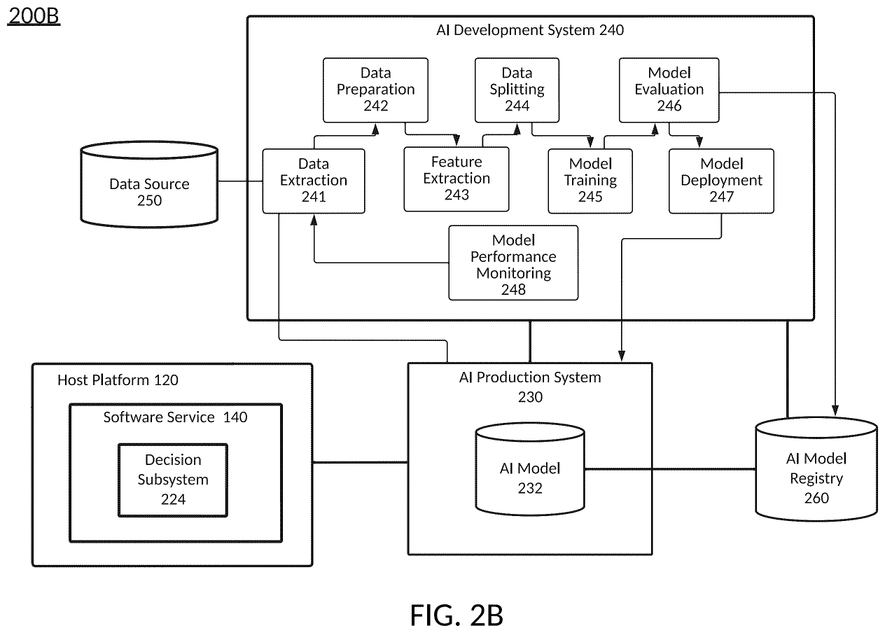

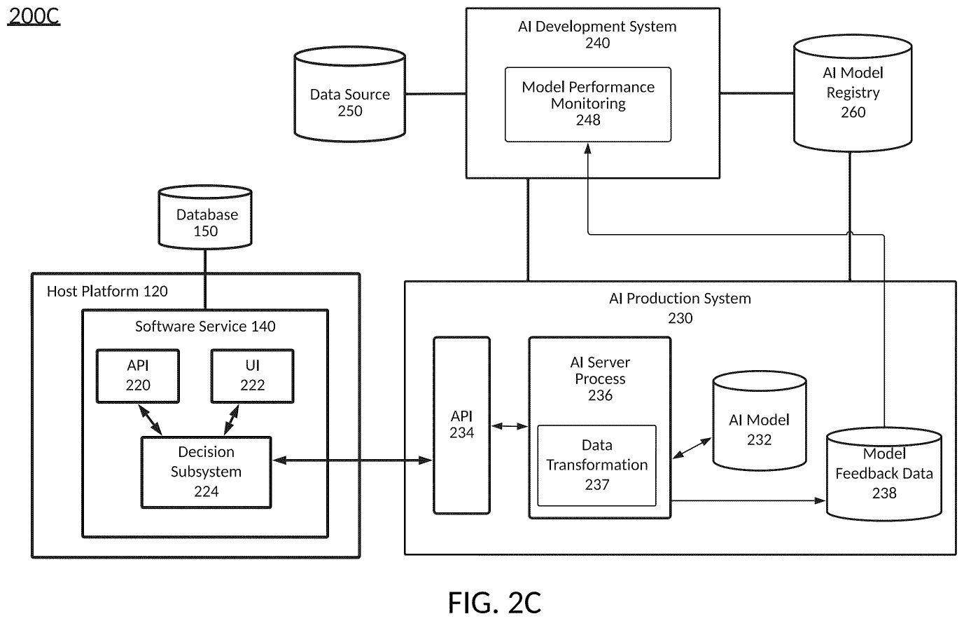

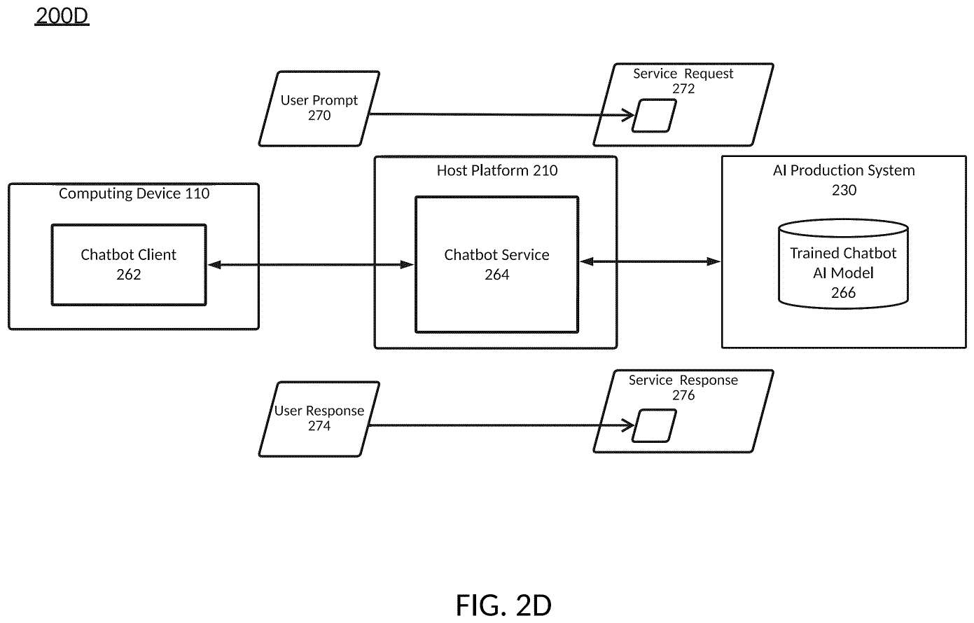

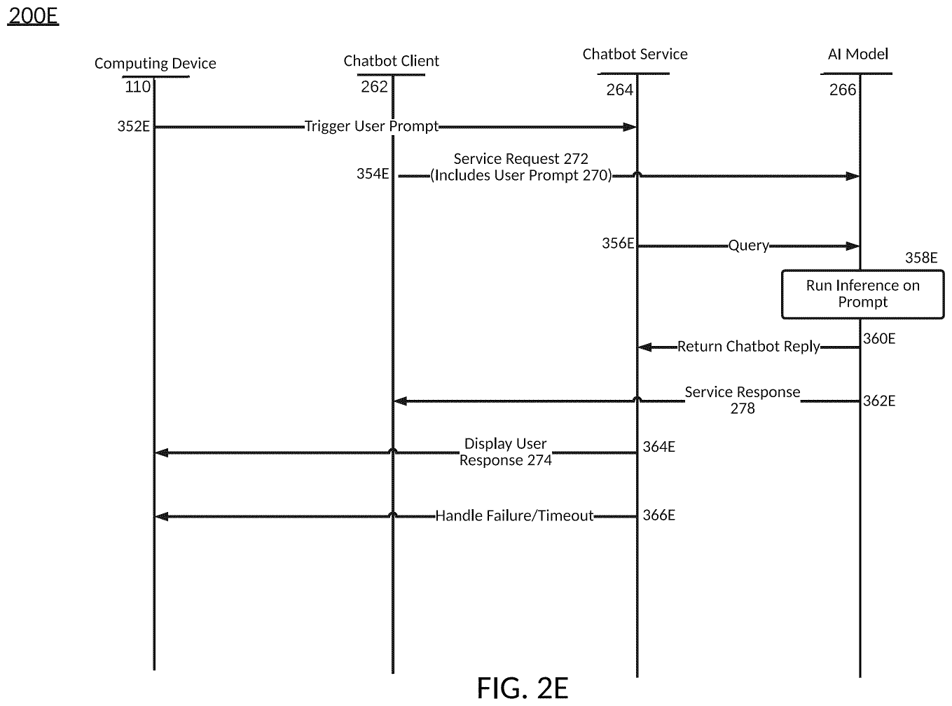

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide at least one API 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of APIs 220 send data to at least one decision subsystem 224 of the software service 140 to assist in decision-making. In some examples and features of the instant solution, the software service 140 stores data included in API requests or data generated during processing the API requests into at least one database 150 (see FIGS. 1, 2A). In some examples and features of the instant solution, software service 140 is a chatbot service.

Software service 140 may provide at least one UI 222, such as a server-side hosted graphical user interface (GUI). In some examples and features of the instant solution, the UIs 222 provided employ template-based frameworks, component-based frameworks, etc. In some examples and features of the instant solution, these UIs 222 send data to at least one decision subsystem 224 of the software service 140 to assist with decision-making. In some examples and features of the instant solution, the software service 140 stores data included in UI requests or data generated during processing the UI requests into at least one database 150.

Software service 140 may include at least one decision subsystem 224 that drive a decision-making process of the software service 140. In some examples and features of the instant solution, the decision subsystem 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes at least one AI model 232 that is executed to generate a response, such as, but not limited to, a prediction, a categorization, a UI prompt, etc. In some examples and features of the instant solution, the AI model 232 has been trained to provide chatbot responses. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

The software service 140 executing on the host platform 120 may coordinate data refinement and model training operations through its decision subsystem 224. Annotated and non-annotated datasets may be obtained from the database 150 or one or more external data sources 250 and converted into respective sets of latent representations. The decision subsystem 224 may perform clustering on the latent vectors derived from the annotated dataset and compute discrepancy scores between the clustered latents and the latent representations generated from the non-annotated dataset. A refined subset of data may be formed by selecting representative samples from each cluster that reduce the overall discrepancy. The refined subset is then processed to compute similarity scores with the non-annotated latents, and an aligned subset is generated by identifying and retaining the highest-scoring latent pairs.

The resulting aligned subset of annotated data is used to train a visual classification model. The training process may be performed either by the software service 140 or offloaded to the AI production system 230, which hosts at least one AI model 232. A UI 222 may allow visualization of training results, alignment quality, or model accuracy metrics. The trained model may be registered with the AI model registry 260 for future retrieval, deployment, or re-use. An AI development system 240 may interact with the data source 250 to generate or retrain models using refined and aligned training data and may provide updated models to the AI production system 230. The aligned subset generation process may be initiated based on new data received from user devices and updated over time to maintain performance under evolving conditions.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a UI (not shown). The UI may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

In one example, an AI development system 240 is configured to process input data and train an AI model 232, such as a machine learning model. The system receives data from at least one data source 250, and optionally one or more AI production systems 230, which may undergo a sequence of preprocessing steps before being used for training a predictive model. The AI development system 240 extracts data related to one or more of the instant features from at least one data source 250 in the data extraction stage 241. This extracted data is then processed through data preparation 242 to normalize or filter relevant information. Feature extraction 243 follows, where meaningful features are identified to increase model performance. The dataset is then split 244 into training and validation subsets.

The AI development system 240 (serving as a machine learning server) is directed to generate a predictive model based on machine learning of the data. The system initiates model training 245 using the prepared dataset. The AI development system 240 selects an appropriate machine learning algorithm and hyperparameters to optimize predictive accuracy. The trained model undergoes model evaluation 246 using validation data to assess performance. When the model meets predefined accuracy thresholds, it is deployed 247 to an AI production system 230 and registered in the AI model registry 260 for use in real-time decision-making.

The AI development system 240 may coordinate the construction of an image classification model that is optimized by refining and aligning training data derived from annotated and non-annotated datasets. The data extraction module 241 retrieves data from at least one data source 250, which may include image files, metadata, user-generated content, and previously inferred outputs. In certain cases, this extracted data includes image samples captured by client devices or feedback signals from previously deployed AI models hosted by the AI production system 230. After extraction, the data is passed to the data preparation module 242, which performs transformations such as normalization, encoding, and statistical filtering. This may include identifying outliers, removing null entries, and performing format conversions to unify annotation schemas or image modalities.

The prepared data is then forwarded to the feature extraction module 243, which applies one or more feature encoders or embedding functions to generate latent representations of the images. These latent vectors are used to form two distinct datasets: a first set of latents derived from the annotated data and a second set of latents derived from the non-annotated data. The AI development system 240 applies a clustering algorithm to the annotated latents and computes a discrepancy score for each cluster in relation to the distribution of the non-annotated latents. A refined subset of annotated samples is selected from the clusters such that their inclusion reduces the overall distributional discrepancy. The system 200C then performs a similarity comparison between the two latent sets and constructs an aligned subset by pairing annotated latents with the most similar non-annotated latents. These aligned pairs are used to construct a representative training dataset.

The resulting aligned dataset is split 244 into training and validation subsets and provided to the model training component 245, which initializes and iteratively updates the parameters of an image classification model. The model may be trained using a supervised learning algorithm with performance tracked on the validation subset. Following training, the model is passed to the model evaluation module 246, which executes in a controlled staging environment designed to emulate real-world deployment conditions. Evaluation metrics may include classification accuracy, confusion matrices, precision-recall statistics, or latent-space divergence tests. Once the model satisfies one or more performance thresholds, it is deployed through the model deployment module 247 to an AI production system 230 and stored in an AI model registry 260 for version control and retrieval.

In production, the AI model 232 may be used to classify live or batch image data, and performance is continuously tracked by a model performance monitoring module 248.

Performance telemetry, including misclassification rates, confidence levels, or distributional drift, is analyzed by the development system to determine when retraining or refinement should be triggered. The decision subsystem 224 within the software service 140, hosted on the host platform 120, may participate in this loop by initiating retraining requests or scheduling inference tasks.

FIG. 2C illustrates a system 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a UI (not shown). The UI may be used to manage the production system infrastructure, the components of the production system 230-238, and the operation of the AI production system and its components.

The instant solution may support an intelligent user interaction framework as illustrated in FIG. 2D, where a computing device 110 hosts a chatbot client 262 configured to capture a user prompt 270. The user prompt may request an image-based decision, classification, or visual confirmation, such as identifying an object in an uploaded image or verifying the scene type from a camera snapshot. The chatbot client 262 packages this request into a service request 272 and transmits it to a chatbot service 264 executing on a host platform 210. The chatbot service 264 parses the prompt, identifies the intent, and interfaces with an AI production system 230, which hosts one or more trained AI models including a trained chatbot AI model 266 and optionally, a visual classification model trained using the latent refinement method of the instant solution.

The AI production system 230 retrieves and executes the appropriate model to handle the incoming request. When the request includes image data (such as a photograph captured by the user device or referenced from cloud storage), the service may invoke a visual classification model trained using a refined, aligned subset of annotated data. This model may have been trained by selecting representative image samples from an annotated dataset that statistically align with non-annotated image inputs collected from user devices. The training pipeline applies latent vector conversion, clustering, discrepancy scoring, and similarity graph pruning to derive a compact yet effective subset for model training. Once the classification model generates a result, such as an object label, confidence score, or bounding box, the chatbot service 264 integrates the result with conversational context and constructs a natural language response. This is returned as a service response 276 and rendered to the user via the chatbot client 262 as a user response 274.

In some configurations, the chatbot client 262 may capture post-response feedback (e.g., whether the classification result was accurate or helpful), which is logged and associated with the original service request. This feedback may be transmitted back to the host platform 210 and used to enrich a model feedback repository, contributing to retraining cycles. Over time, this enables the system to iteratively increase the accuracy of both language-based and visual classification responses.

FIG. 2D is a system diagram 200D illustrating a chatbot service that utilizes an AI model. Referring to FIG. 2D, a computing device 110 (see FIGS. 1, 2D) may host a chatbot client 262 which interworks with a chatbot service 264 executing on a host platform 120 (see FIGS. 1, 2D). Further, the chatbot service 264 utilizes a trained chatbot AI model 266 that is resident on an AI production system 230 (see FIGS. 2A-2D). In some examples and features of the instant solution, the chatbot client 262 is an example of a service client 160, depicted in FIG. 1. In some examples and features of the instant solution, the chatbot service 264 is an example of software service 140 (see FIG. 2A) which includes an API 220 (see FIG. 2A), a UI 222 (see FIG. 2A) and at least one decision subsystem 224 (see FIG. 2A). In some examples and features of the instant solution, the trained chatbot AI model 266 is an example of AI model 232 (see FIGS. 2A-2C) which is hosted on an AI production system 230 (see FIGS. 2A-2D). In some examples and features of the instant solution, the AI production system 230 (see FIG. 2D) includes the internal architectural elements depicted in FIG. 2C.

The chatbot client 262 accepts and captures a user prompt 270 which it sends to the chatbot service 264. Upon receiving the user prompt 270, the chatbot service 264 builds a service request 272 that includes the user prompt 270. In some examples and features of the instant solution, the service request 272 may include a target AI model identifier, such as an identifier to a trained chatbot AI model 266. Once built, the service request 272 is delivered to the AI production system 230 (see FIGS. 2A-2D). Upon receipt of the service request 272, the AI production system 230 determines the target AI model, such as the trained chatbot AI model 266, and extracts the user prompt 270. In some examples and features of the instant solution, the AI production system transforms the user prompt 270 using natural language understanding (NLU) or natural language processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. In some examples and features of the instant solution, the trained chatbot AI model 266 utilizes neural networks or natural language generation (NLG) techniques in order to determine the appropriate user response 274.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it.

The instant solution supports an intelligent user interaction framework as illustrated in FIG. 2D, where a computing device 110 hosts a chatbot client 262 configured to capture a user prompt 270. The user prompt may request an image-based decision, classification, or visual confirmation, such as identifying an object in an uploaded image or verifying the scene type from a camera snapshot. The chatbot client 262 packages this request into a service request 272 and transmits it to a chatbot service 264 executing on a host platform 210. The chatbot service 264 parses the prompt, identifies the intent, and interfaces with an AI production system 230, which hosts one or more trained AI models including a trained chatbot AI model 266 and optionally, a visual classification model trained using the latent refinement method of the instant solution.

The AI production system 230 retrieves and executes the appropriate model to handle the incoming request. When the request includes image data (such as a photograph captured by the user device or referenced from cloud storage), the service may invoke a visual classification model trained using a refined, aligned subset of annotated data. This model may have been trained by selecting representative image samples from an annotated dataset that statistically align with non-annotated image inputs collected from user devices. The training pipeline applies latent vector conversion, clustering, discrepancy scoring, and similarity graph pruning to derive a compact yet effective subset for model training. When the classification model generates a result, such as an object label, confidence score, or bounding box, the chatbot service 264 integrates the result with conversational context and constructs a natural language response. This is returned as a service response 276 and rendered to the user via the chatbot client 262 as a user response 274.

The chatbot client 262 may capture post-response feedback (e.g., whether the classification result was accurate or helpful), which is logged and associated with the original service request. This feedback may be transmitted back to the host platform 210 and used to enrich a model feedback repository, contributing to retraining cycles. Over time, this enables the system to iteratively increase the accuracy of both language-based and visual classification responses.

FIG. 2E illustrates a sequence diagram 200E for managing a conversational interaction between a user and an AI model using a chatbot service, where the AI model is a trained chatbot AI model. The process begins in step 352E, where a computing device 110 initiates a prompt event and triggers a user prompt via a chatbot client 262. The chatbot client 262 may include a UI for capturing textual or multimodal inputs such as questions, image references, classification tasks, or other structured or unstructured queries.

In step 354E, the chatbot client 262 generates a service request 272 containing the user prompt 270. This service request is transmitted to a chatbot service 264, which is hosted on a backend server or host platform. The chatbot service 264 receives the prompt and issues a query 356E to an AI model 266, which may include a chatbot model, an image classification model, or a hybrid decision model depending on the prompt content. The AI model 266 runs inference on prompt 358E logic using the prompt content as input. This may include natural language understanding, latent vector encoding, or invoking a classification pipeline when the prompt includes or references image data.

Upon completing inference, the AI model 266 generates a reply and returns the chatbot reply 360E to the chatbot service 264. The chatbot service packages the result into a structured service response 278 and transmits it back to the chatbot client 262 at step 362E. The chatbot client processes and displays the user response 274 on the computing device in step 364E, allowing the user to view the result or continue the interaction. In the event of an execution error, network delay, or model unavailability, a failure or timeout condition may be detected and handled in step 366E. This step may involve error logging, user notification, fallback execution, or retry logic to ensure graceful degradation of service.

The inference performed by the AI model 266 may include visual classification logic trained using the refined latent-based pruning process described in earlier figures. The model may utilize an aligned subset of annotated data that statistically matches the latent distribution of image data originating from user devices. The chatbot service 264 may incorporate confidence thresholds, prompt-type routing logic, or response templating modules to support a seamless user experience and facilitate integration with other platform services.

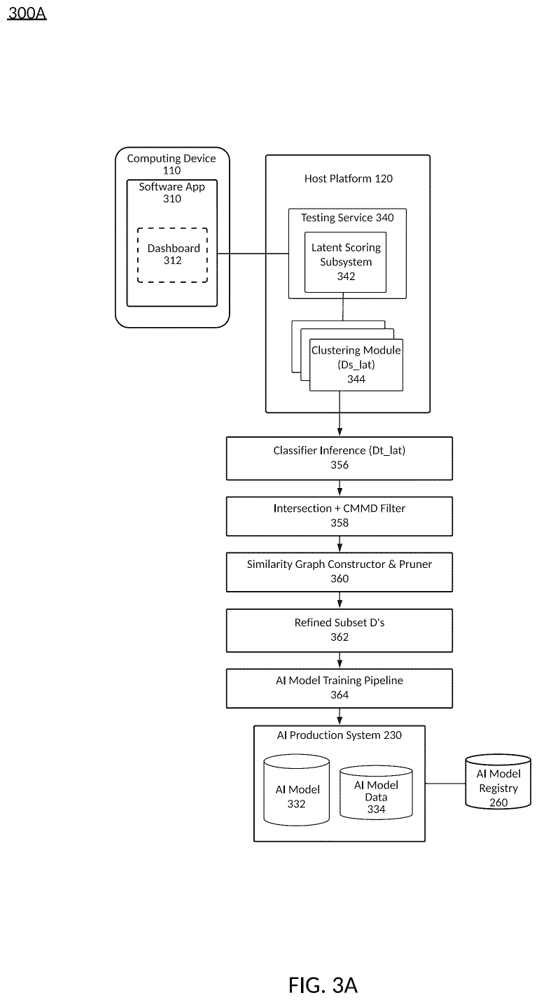

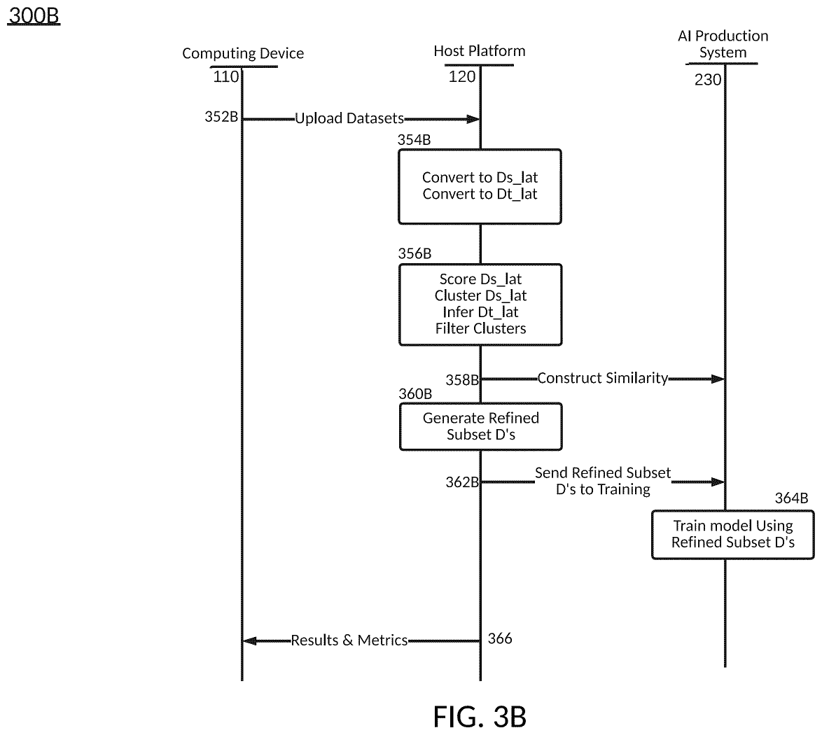

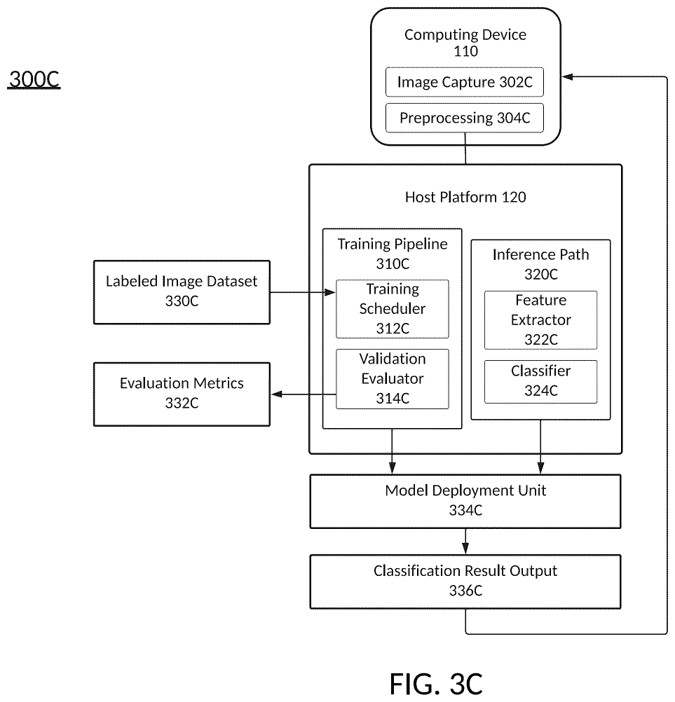

FIG. 3A illustrates an implementation architecture 300A for latent-based data refinement, alignment, and visual model training. A computing device 110 communicates with a host platform 120 to participate in data collection and model refinement workflows. The computing device 110 may be any mobile or embedded system, and it includes a software app 310 that features a dashboard 312. This dashboard may present real-time training feedback, latent scoring metrics, subset alignment quality, or model deployment options to an end user or administrator.

The host platform 120 includes a testing service 340 comprising a latent scoring subsystem 342. This component receives both an annotated dataset and a non-annotated dataset, which may be stored locally or retrieved from a shared data repository as shown in FIG. 2A and FIG. 2B (e.g., database 150 or data source 250). The latent scoring subsystem 342 encodes these datasets into respective latent spaces: the annotated set is transformed into Ds_lat and the non-annotated set into Dt_lat. The latent representations may be derived using a shared encoder or embedding network previously trained on visual data.

The annotated latent vectors Ds_lat are then processed by a clustering module 344, which segments the embeddings into a plurality of clusters using functionality such as k-means, DBSCAN, or hierarchical clustering. These clusters are then passed through classifier inference 356 logic that evaluates the non-annotated latent vectors Dt_lat. At this stage, the system computes a statistical alignment score between clusters and target latents. Using techniques such as conditional maximum mean discrepancy (CMMD), the intersection+CMMD filter 358 identifies which clusters contain annotated samples that, when included in training, reduce the discrepancy between the two latent spaces.

In similarity graph constructor and pruner 360, the system constructs a similarity graph between the refined annotated latent subset and the non-annotated latents. Each edge in the graph represents a similarity score, such as cosine similarity or Euclidean proximity, and a pruning algorithm is applied to retain the strongest links. This graph pruning process selects the annotated samples most closely aligned with non-annotated data. The result is a refined subset D's 362, which contains high-quality, contextually aligned training examples selected from the annotated dataset. This process echoes the latent alignment and similarity selection flow and procedurally in FIG. 3C.

The refined subset D's is then passed into an AI model training pipeline 364, where a visual classification model is trained using the selected samples. The trained model and its associated metadata, weight checkpoints, and training metrics are stored in an AI production system 230, specifically in AI model 332 and AI model data 334 repository. The model is registered in a centralized AI model registry 260, enabling subsequent deployment to production endpoints or retrieval for retraining.

The refined subset D's may originate from a dynamic feedback loop involving the AI model performance monitoring 248 system illustrated in FIG. 2B. In such a case, non-annotated latents may be derived from inference data collected from end-user devices or production logs. The scoring, filtering, and pruning process shown in FIG. 3A may be triggered conditionally when the discrepancy between model predictions and incoming data exceeds a threshold, enabling continual adaptation.

By integrating clustering, scoring, and graph-based pruning into a single automated pipeline, the system produces a deployable model that performs well in live settings while reducing the labeling burden. The AI model training pipeline 364 may be integrated with edge-deployable classifiers, such as those shown in the inference configurations of FIG. 2D and FIG. 3C, enabling on-device object detection and image classification.

The instant solution may support on-device latent storage to enable edge-based personalization and localized adaptation of image classification models. A computing device 110, such as that shown in FIG. 3A, may include a software app 310 with capabilities for capturing and preprocessing image data and generating corresponding latent representations using an encoder shared with the host platform. These latent vectors, once generated, may be stored persistently on the user device, allowing the system to operate independently of a centralized server during adaptation phases.

By storing both non-annotated latents derived from local image capture and a selectively retained set of annotated latents, the device can perform context-specific optimization. For example, the latent scoring subsystem 342 from FIG. 3A may be instantiated in a lightweight form on the device to compute alignment scores between stored non-annotated latents and clusters of annotated ones. Clustering operations, like those managed by the clustering module 344, may also be partially executed on-device using reduced-dimensionality vectors, allowing clusters to be identified that reflect the most frequently observed visual conditions, such as a specific lighting profile, angle of view, or object composition relevant to the user's environment.

The instant solution may enable context-aware pruning at the edge by using the classifier inference 356 component and intersection+CMMD filtering 358 to determine which annotated clusters help minimize statistical discrepancy with locally observed data. Based on this analysis, the similarity graph constructor and pruner 360 can be used to identify and retain the most relevant latent pairings. These selected latents are compiled into a refined subset D's 362, which can be passed into a local instance of the AI model training pipeline 364 to fine-tune or recalibrate the model stored on the device. Such localized optimization workflows are particularly useful in privacy-sensitive or bandwidth-constrained environments where frequent server retraining is infeasible. For example, a smart camera system executing on computing device 110 may periodically assess captured scenes using the latent scoring subsystem 342 and adjust its model to increase object detection performance for high-frequency scenarios like a user's driveway or workplace entrance. By maintaining a local cache of Ds_lat and Dt_lat, the device can generate updated model parameters using locally stored data and then deploy those updates without requiring cloud inference.

The AI production system 230 in FIG. 3A may be used to deploy the initially trained AI model 332, but subsequent refinement can occur at the device level using the techniques described above. The resulting model state may optionally be registered or synchronized back to the central AI model registry 260 when connectivity allows, thus contributing to a hybrid federated training framework allowing real-time personalization and environmental adaptation. For example, when the device observes a seasonal shift in lighting or an increase in nighttime activity, the latent storage and alignment system may automatically adapt the model to prioritize low-light classification robustness without requiring annotated examples of such shifts.

In a practical application of the instant solution, the system may be deployed in a mobile smart camera environment, such as a vehicle-mounted or home surveillance system, where real-time image classification is expected under changing and user-specific conditions. In this scenario, the computing device 110 operates as the capture and processing interface, equipped with a software app 310 capable of interfacing with the host platform 120. The software application may expose a dashboard 312 that visualizes model accuracy, training progression, or environmental drift detected via local data capture.

As image data is acquired by the computing device, it is converted into latent representations using a shared feature encoder, and these latents are either stored locally or transmitted to the host platform for further processing. The host platform includes a latent scoring subsystem 342 within the testing service 340 that analyzes both annotated training data and newly captured non-annotated input. The clustering module 344 segments the annotated latents (Ds_lat) into clusters to assess their internal coherence and identify representational redundancies.

The classifier inference 356 stage processes the target latents (Dt_lat), derived from non-annotated data, and compares them with cluster distributions using a discrepancy analysis such as intersection+CMMD filtering 358 enabling the system to identify which clusters of annotated data reduce the discrepancy between the training distribution and the real-world data captured by the user's device. A similarity graph is constructed between the refined annotated and non-annotated latents by the similarity graph constructor and pruner 360, and a refined subset D's 362 of annotated samples is selected. This subset is passed into the AI model training pipeline 364, which fine-tunes or updates the image classification model specifically for the data distribution encountered by that user.

The fine-tuned model is deployed to the AI production system 230, where it is stored as AI model 332 and its associated configuration or metadata is stored as AI model data 334. These updates may also be registered with the AI model registry 260 for tracking and possible federation across multiple edge devices.

For example, a smart doorbell system operating the instant solution may frequently observe vehicles and pedestrians during specific hours and lighting conditions. Over time, by capturing local image data, converting it to latents, and periodically running the described refinement steps via components 342-364, the doorbell system can personalize its object detection model to more accurately classify delivery trucks, parked cars, or pets near the property, even under adverse lighting.

FIG. 3B illustrates a sequential interaction diagram 300B representing the end-to-end data refinement and model training workflow used for generating image classification models based on latent alignment and operationalized in the system architecture of FIG. 3A. The sequence involves interactions between a computing device 110, a host platform 120, and an AI production system 230.

In step 352B, the computing device 110 initiates the workflow by uploading two datasets to the host platform 120: an annotated dataset and a non-annotated dataset. The annotated dataset contains labeled image data, while the non-annotated dataset may include unlabeled images collected from the user's environment or device sensors, as described previously in FIGS. 2A and 3C.

In step 354B, the host platform processes both datasets by converting them into their respective latent vector representations: Ds_lat for the annotated set and Dt_lat for the non-annotated set. These latent vectors are generated using a shared encoder or embedding model and serve as the basis for downstream clustering and alignment.

In step 356B, the annotated latents Ds_lat are passed into a scoring and clustering module, where they are grouped into a plurality of clusters. Simultaneously, inference is performed on the non-annotated latents Dt_lat to analyze distributional characteristics. The system then filters the clusters using a CMMD strategy, as originally illustrated in FIG. 3A, identifying clusters whose members reduce the statistical divergence between the two latent spaces.

In step 358B, the host platform constructs a similarity graph that compares each retained annotated latent with non-annotated latents based on a selected similarity metric (e.g., cosine similarity, dot product). This similarity graph is pruned to extract the highest-scoring pairwise relationships, allowing the system to form a refined and aligned subset of annotated data, denoted D's.

In 360B, the refined subset is finalized, and in step 362B it is transmitted to the AI production system 230 for model training. The AI production system initiates model training at step 364B using the aligned subset D's, as previously shown in the AI model training pipeline 364 of FIG. 3A. This produces a compact, high-precision visual classification model that reflects the deployment distribution of real-world, unlabeled data captured from devices like computing device 110.

In step 366B, training results and evaluation metrics, such as classification accuracy, loss convergence, or latent-space fidelity, are returned to the computing device 110. These results may be surfaced in the dashboard interface (see dashboard 312 in FIG. 3A) for user review or configuration adjustments. In some implementations, model versioning and performance metadata may also be pushed to the AI model registry 260 shown in FIG. 3A or used to trigger performance monitoring logic as described in FIG. 2B.

The computation of the discrepancy score may be performed within the testing service 340, and more specifically through the latent scoring subsystem 342 and intersection+CMMD filter 358. Initially, the annotated dataset is transformed into a set of latent vectors, which are then grouped into a plurality of clusters via the clustering module 344. Each cluster corresponds to a subset of semantically similar latent representations derived from annotated data. The non-annotated dataset is converted into its own latent vector representation. To evaluate how well each annotated cluster matches the distribution of the non-annotated data, a statistical divergence technique is applied by the intersection+CMMD filter 358. This step computes a discrepancy score for each cluster by measuring its distributional difference relative to the overall distribution of the non-annotated latent vectors. Clusters with lower discrepancy scores are considered more aligned with the target data distribution. These discrepancy scores guide a downstream selection process that retains data from clusters representing the unlabeled domain, resulting in a refined subset of annotated data that is statistically optimized for use in training.

An example operation of the instant solution may include creating an aligned subset of data from an annotated dataset comprising: clustering a first set of latents into a plurality of clusters, determining a discrepancy score for each cluster in the plurality of clusters and a second set of latents, creating a refined subset of data from the annotated dataset by including at least one data from each cluster of the plurality of clusters, wherein adding the at least one data lowers the discrepancy score of the refined subset of data and the second set of latents, determining a similarity score between latents in the first set of latents and the second set of latents, and creating the aligned subset of data from the annotated dataset by dividing the refined subset into pairs of latents and for each of the pairs of latents, including a latent with a highest similarity score. The operation may also include the aligned subset of data from the annotated dataset comprising a representative subset of data from the annotated dataset aligned with a non-annotated dataset, wherein the representative subset of data is utilized for image classification instead of the annotated dataset. The operation may also include the first set of latents being determined using a vision transformer (ViT) on a contrastive language-image pretraining (CLIP) model, and the second set of latents are determined by the Vision Transformer. The operation may also include the discrepancy score being determined by a CMMD value. The operation may also include ranking clusters in an ascending order based on a CMMD value. The operation may also include the clustering comprising partitioning the first set of latents into the plurality of clusters using k-means clustering. The operation may also include the creating the aligned subset comprising a trained distribution classifier trained to select samples from the annotated dataset that share similarities with a non-annotated dataset. The operation may also include converting the annotated dataset loaded from a storage into the first set of latents. The operation may also include converting a non-annotated dataset loaded from a storage into the second set of latents. The method of claim 1, comprising converting a non-annotated dataset loaded from a storage into the second set of latents.

FIG. 3C illustrates a system diagram 300C for implementing the model training and inference stages of a visual classification pipeline that utilizes an aligned subset of annotated data refined through latent-based filtering techniques described in FIGS. 3A, and 3B. The system is composed of two processing environments: a computing device 110 and a host platform 120, wherein the host platform 120 can also provide model training and inference capabilities and thus may be referred to herein as model training/inference platform 120. The computing device 110 may include embedded or peripheral hardware for image capture 302C and local image preprocessing 304C. The image data captured may originate from a mobile phone camera, IoT sensor, or similar image acquisition source and can be stored or streamed to the model training platform.

The host platform 120, being a model training/inference platform, includes a training pipeline 310C and an inference path 320C. The training pipeline 310C accepts a labeled image dataset 330C as input. In preferred implementations, the labeled image dataset 330C corresponds to a refined subset of annotated samples selected through latent-space clustering and similarity scoring (as described in FIG. 3A, refined subset D's 362, and FIG. 3B, generate refined subset D's 360B). This dataset is passed to a training scheduler 312C, which orchestrates batch sampling, learning rate scheduling, and checkpointing. A validation evaluator 314C performs in-process performance monitoring using held-out data, returning evaluation metrics 332C such as classification accuracy, recall, confusion matrices, or divergence scores.

The resulting model is provided to a model deployment unit 334C. This unit prepares the model for inference by packaging the trained parameters, establishing pre- and post-processing logic, and deploying the model to on-premise or edge environments. In production use, inference is handled by the inference path 320C, which includes a feature extractor 322C and a classifier 324C. The feature extractor 322C transforms raw image inputs into embedded representations, and the classifier 324C outputs label predictions, which are surfaced to users or downstream applications through a classification result output 336C.

In some implementations, the inference stage uses input data from the same computing device 110 that originally contributed non-annotated examples during training data alignment (see FIG. 3A). This feedback loop ensures consistency between the latent distributions observed at training and those encountered in deployment. The classifier 324C may be periodically updated with retrained weights derived from an updated version of labeled image dataset 330C, particularly when the host platform receives feedback from post-deployment image streams or classification results.

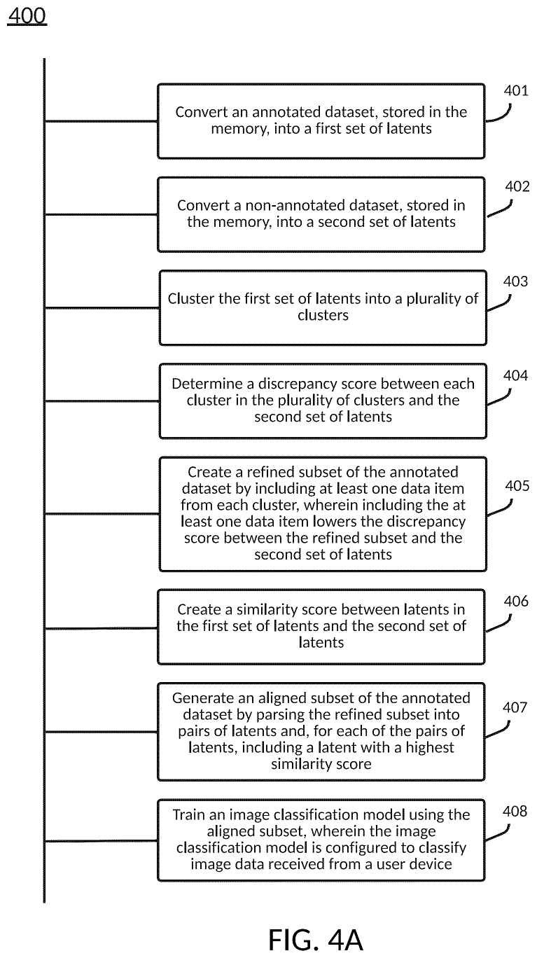

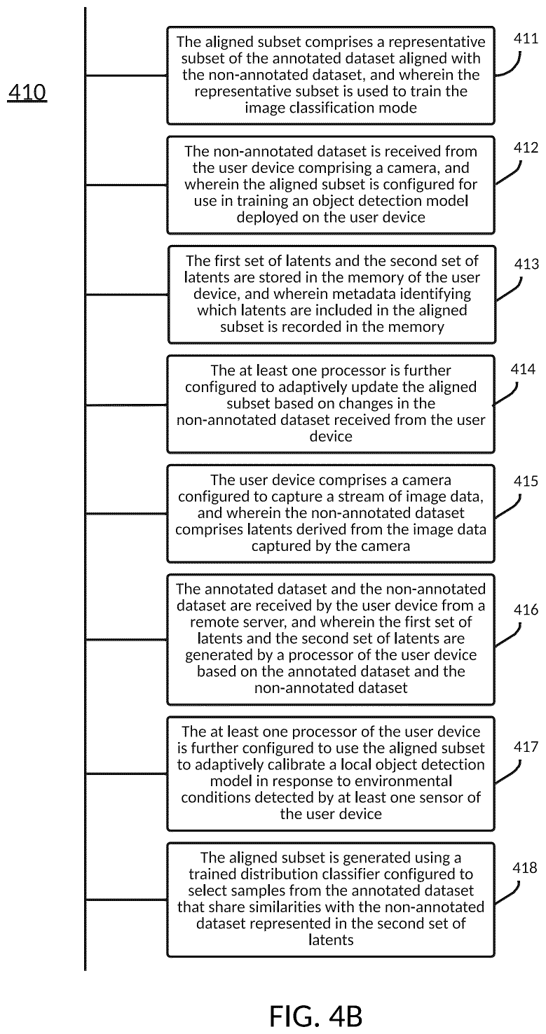

FIG. 4A illustrates an example of a method 400 for image classification model training using latent-based cluster filtering and aligned subset selection service, according to examples and features of the instant solution. As an example, the method 400 may be performed by a computing system, a software application, a server, a cloud platform, a combination of systems, and the like. Referring to FIG. 4A, in 401, the method may include Convert an annotated dataset, stored in the memory, into a first set of latents. In 402, the method may include convert a non-annotated dataset, stored in the memory, into a second set of latents. In 403, the method may include cluster the first set of latents into a plurality of clusters. In 404, the method may include determine a discrepancy score between each cluster in the plurality of clusters and the second set of latents. In 405, the method may include create a refined subset of the annotated dataset by including at least one data item from each cluster, wherein including the at least one data item lowers the discrepancy score between the refined subset and the second set of latents. In 406, the method may include create a similarity score between latents in the first set of latents and the second set of latents. In 407, the method may include generate an aligned subset of the annotated dataset by parsing the refined subset into pairs of latents and, for each of the pairs of latents, including a latent with a highest similarity score. In 408, the method may include train an image classification model using the aligned subset, wherein the image classification model is configured to classify image data received from a user device.

FIG. 4B illustrates a method 410 for image classification model training using latent-based cluster filtering and aligned subset selection service, according to other examples and features of the instant solution. As an example, the method 410 may be performed by a computing system, a software application, a server, a cloud platform, a combination of systems, and the like. Referring to FIG. 4B, in 411, the method may include the aligned subset of data from the annotated dataset comprising a representative subset of data from the annotated dataset aligned with the non-annotated dataset, wherein the representative subset of data is utilized for image classification model. In 412, the method may include the non-annotated dataset is received from the user device comprising a camera, and wherein the aligned subset is configured for use in training an object detection model deployed on the user device. In 413, the method may include the first set of latents and the second set of latents are stored in the memory of the user device, and wherein metadata identifying which latents are included in the aligned subset is recorded in the memory. In 414, the method may include the at least one processor is further configured to adaptively update the aligned subset based on changes in the non-annotated dataset received from the user device. In 415, the method may include the user device comprises a camera configured to capture a stream of image data, and wherein the non-annotated dataset comprises latents derived from the image data captured by the camera. In 416, the method may include the annotated dataset and the non-annotated dataset are received by the user device from a remote server, and wherein the first set of latents and the second set of latents are generated by a processor of the user device based on the annotated dataset and the non-annotated dataset. In 417, the method may include the at least one processor of the user device is further configured to use the aligned subset to adaptively calibrate a local object detection model in response to environmental conditions detected by at least one sensor of the user device. In 418, the method may include the aligned subset is generated using a trained distribution classifier configured to select samples from the annotated dataset that share similarities with the non-annotated dataset represented in the second set of latents.

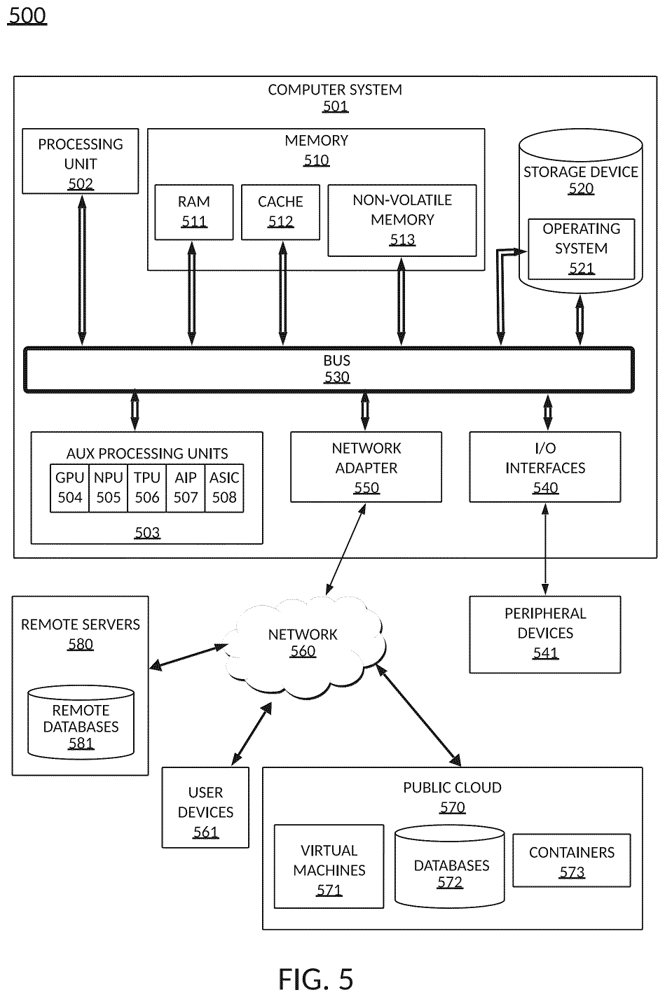

The examples and features of the instant solution may be implemented in at least one of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain at least one Graphics Processing Unit (GPU) 504, Neural Processing Unit (NPU) 505, Tensor Processing Unit (TPU) 506, AI Processor (AIP) 507, or other Application Specific Integrated Circuit (ASIC) 508. The at least one APU 503 may contain circuitry distributed over multiple integrated circuit chips. Each APU 503 may implement multiple processor threads and multiple processor cores. Each APU 503 may include at least one of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, at least one of the at least one APU 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing device. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The UI may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

The host platform 120 and associated modules shown in FIG. 3A, including the latent scoring subsystem 342, clustering module 344, classifier inference 356, intersection+CMMD filter 358, similarity graph constructor and pruner 360, and AI model training pipeline 364, may be executed by the processing unit 502 or auxiliary processing units 503, such as GPU 504 or NPU 505. The computing device 110 of FIG. 3A, which initiates dataset uploads and may host a software dashboard (e.g., dashboard 312), corresponds to user devices 561. These user devices may capture non-annotated visual data using onboard image sensors and transmit it through network 560 to the computer system 501 for training alignment and model generation.

The training pipeline 310C and inference path 320C shown in FIG. 3C may also execute within computer system 501, with the labeled image dataset 330C stored in non-volatile memory 513 or in local/remote databases such as storage device 520 or remote databases 581. Trained models (e.g., AI model 332 in FIG. 3A) may be deployed to containers 573 or virtual machines 571 within the public cloud 570 for scalable inference execution. Inference tasks may then be served back to user devices 561 through network adapter 550 and network 560. Evaluation metrics 332C and classification result output 336C may be processed locally using memory 510 or uploaded to cloud-based infrastructure (e.g., databases 572) for real-time monitoring and optimization. The AI model registry 260 of FIG. 3A may be implemented using either storage device 520, remote databases 581, or databases 572 in public cloud 570 to support version control and deployment tracking.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. A system, comprising:
a memory; and
at least one processor communicatively coupled to the memory, wherein the at least one processor is configured to:
convert an annotated dataset, stored in the memory, into a first set of latents;
convert a non-annotated dataset, stored in the memory, into a second set of latents;
cluster the first set of latents into a plurality of clusters;
determine a discrepancy score between each cluster in the plurality of clusters and the second set of latents;
create a refined subset of the annotated dataset by including at least one data item from each cluster, wherein including the at least one data item lowers the discrepancy score between the refined subset and the second set of latents;
create a similarity score between latents in the first set of latents and the second set of latents;
generate an aligned subset of the annotated dataset by parsing the refined subset into pairs of latents and, for each of the pairs of latents, including a latent with a highest similarity score; and
train an image classification model using the aligned subset, wherein the image classification model is configured to classify image data received from a user device.

2. The system of claim 1, wherein the aligned subset comprises a representative subset of the annotated dataset aligned with the non-annotated dataset, and wherein the representative subset is used to train the image classification model.

3. The system of claim 1, wherein the non-annotated dataset is received from the user device comprising a camera, and wherein the aligned subset is configured for use in training an object detection model deployed on the user device.

4. The system of claim 1, wherein the first set of latents and the second set of latents are stored in the memory of the user device, and wherein metadata identifying which latents are included in the aligned subset is recorded in the memory.

5. The system of claim 1, wherein the at least one processor is further configured to adaptively update the aligned subset based on changes in the non-annotated dataset received from the user device.

6. The system of claim 1, wherein the user device comprises a camera configured to capture a stream of image data, and wherein the non-annotated dataset comprises latents derived from the image data captured by the camera.

7. The system of claim 1, wherein the annotated dataset and the non-annotated dataset are received by the user device from a remote server, and wherein the first set of latents and the second set of latents are generated by a processor of the user device based on the annotated dataset and the non-annotated dataset.

8. The system of claim 1, wherein the at least one processor of the user device is further configured to use the aligned subset to adaptively calibrate a local object detection model in response to environmental conditions detected by at least one sensor of the user device.

9. The system of claim 1, wherein the aligned subset is generated using a trained distribution classifier configured to select samples from the annotated dataset that share similarities with the non-annotated dataset represented in the second set of latents.

10. A method comprising:
converting an annotated dataset loaded from a storage into a first set of latents;
converting a non-annotated dataset loaded from the storage into a second set of latents;
creating an aligned subset of data from the annotated dataset comprising:
clustering the first set of latents into a plurality of clusters;
determining a discrepancy score for each cluster in the plurality of clusters and the second set of latents;
creating a refined subset of data from the annotated dataset by including at least one data from each cluster of the plurality of clusters, wherein adding the at least one data lowers the discrepancy score of the refined subset of data and the second set of latents;
determining a similarity score between latents in the first set of latents and the second set of latents;
wherein the aligned subset of data is created from the annotated dataset by parsing the refined subset into pairs of latents and for each of the pairs of latents, including a latent with a highest similarity score; and
training an image classification model using the aligned subset, the image classification model configured to classify image data received from a user device.

11. The method of claim 10, wherein the aligned subset of data from the annotated dataset comprises a representative subset of data from the annotated dataset aligned with the non-annotated dataset, wherein the representative subset of data is utilized for image classification model.

12. The method of claim 10, wherein the non-annotated dataset is received from the user device comprising a camera, and wherein the aligned subset of data from the annotated dataset is configured for use in training an object detection model deployed on the user device.

13. The method of claim 10, wherein the first set of latents and the second set of latents are stored in a memory of the user device, and wherein metadata identifying which latents are included in the aligned subset is recorded in the memory.

14. The method of claim 10, further comprising adaptively updating the aligned subset of data based on changes in the non-annotated dataset received from the user device.

15. The method of claim 10, wherein the user device comprises a camera configured to capture a stream of image data, and wherein the non-annotated dataset comprises latents derived from the image data captured by the camera.

16. The method of claim 10, wherein the annotated dataset and the non-annotated dataset are received by the user device from a remote server, and wherein the first set of latents and the second set of latents are generated by a processor of the user device based on the annotated dataset and the non-annotated dataset.

17. The method of claim 10, wherein the aligned subset of data from the annotated dataset is used by the user device to adaptively calibrate a local object detection model in response to environmental conditions detected by at least one sensor of the user device.

18. The method of claim 10, wherein the creating the aligned subset comprises a trained distribution classifier trained to select samples from the annotated dataset that share similarities with the non-annotated dataset into the second set of latents.

19. A computer program product comprising:
one or more non-transitory computer-readable storage media; and
program instructions stored on the one or more non-transitory computer-readable storage media that, when executed by at least one processor, cause the at least one processor to:
converting an annotated dataset loaded from a storage into a first set of latents;
converting a non-annotated dataset loaded from the storage into a second set of latents;
creating an aligned subset of data from the annotated dataset comprising:
clustering the first set of latents into a plurality of clusters;
determining a discrepancy score for each cluster in the plurality of clusters and the second set of latents;
creating a refined subset of data from the annotated dataset by including at least one data from each cluster of the plurality of clusters, wherein adding the at least one data lowers the discrepancy score of the refined subset of data and the second set of latents;
determining a similarity score between latents in the first set of latents and the second set of latents;
wherein the aligned subset of data is created from the annotated dataset by parsing the refined subset into pairs of latents and for each of the pairs of latents, including a latent with a highest similarity score; and
training an image classification model using the aligned subset, the image classification model configured to classify image data received from a user device.

20. The computer program product of claim 19, wherein the aligned subset of data from the annotated dataset comprises a representative subset of data from the annotated dataset aligned with the non-annotated dataset, wherein the representative subset of data is utilized for image classification model.
